(19) United States
(12) Patent Application Publication
(10) Pub. No.: US 2025/0277542 A1
(43) Pub. Date: Sep. 4, 2025

(54) ACTUATOR ASSEMBLY AND METHOD OF USE

(71) Applicant: SPEO Products AS, Kristiansand S (NO)

(72) Inventors: Bernt ERIKSEN, Sola (NO); Tor Ove BRÅTHEN, Kristiansand S (NO); Carlos BRICENO, Kristiansand S (NO)

(73) Assignee: SPEO Products AS, Kristiansand S (NO)

(21) Appl. No.: 18/862,239

(22) PCT Filed: Apr. 13, 2023
(86) PCT No.: PCT/NO2023/050083

§ 371 Date: Nov. 1, 2024

(30) Foreign Application Priority Data
May 3, 2022 (NO) 20220503
Dec. 15, 2022 (NO) 20221340

(51) Int. Cl. F16K 31/42; F15B 1/24; F15B 20/00

(52) U.S. Cl. CPC F16K 31/423; F15B 1/24; F15B 20/002; F15B 2211/327; F15B 2211/8752

(57) ABSTRACT

An actuator system is for use with a safety critical valve. The actuator system has: a low-pressure accumulator with a first energy store and a first hydraulic fluid chamber; a high-pressure accumulator having a second energy store and a second hydraulic fluid chamber; a pump; a directional control valve; an actuator and hydraulic fluid connections; wherein the pump is configured to recharge the high-pressure accumulator such that if the control signal or electrical power is lost to the directional control valve in use, the directional control valve will automatically open or close the actuator.

### FIELD

The present invention relates to an actuator assembly. In particular, the invention relates to an actuator assembly used to control a wellhead valve or any other high power, low frequency valve, particularly safety critical valves where it is desired that the valve closes on loss of control and/or power.

### BACKGROUND

Oil and gas operations make use of large valves to control the flow of dangerous fluids from the well. Typically, valves on wellheads are operated using hydraulic actuators connected to a Wellhead Control Panel (WHCP) to move the valves between open and closed positions. The most common way to operate valves on wellheads is to use hydraulic actuators connected to a Wellhead Control Panel (WHCP) to move the valves between open and closed position. The control and operation of the valves are directed from this panel, and a top-level Safety Automation System performs the actual closing of the valves by use of the WHCP. The hydraulic control fluid, typically oil, is pressurized by a hydraulic power unit (HPU) at typically 210 bar and transported in pipelines and hoses to the valve actuators.

High power, low frequency operation of valves is also common in other industries, such as in hydroelectric power plants, where a valve at a lake or reservoir must be opened to allow the flow of water down to the turbine. These valves have a very low frequency of operation, however the power required to open such valves is high. Additionally, such valves are safety critical, in that in a situation where power or the control signal is lost to the valve, it is highly desirable for the valve to return to the closed position until power and control is regained, these valves are so called “fail-safe close” valves. There are many other industries which may make use of high power, low frequency fail-safe closed valves, such as valves in supply pipelines of hydro power plants, pipeline end manifolds (PLEMs) etc.

In some recent applications, electric actuators have been used for operation of valves. These are normally operated by 400 Volt three-phase systems connected to variable frequency drives for operation. A drawback with the fully electrically operated actuators is a significant consumption of electric power, which may be difficult to provide at remote areas, such as on offshore platforms. In addition, electric systems are space consuming as they require on-board designated electrical rooms located in “safe” areas to house frequency converters, drives and other electrical equipment.

Actuators used in wellhead applications are designed to be “fail-safe close”. A fail-safe actuator normally uses a spring to provide the necessary force needed for emergency/automatic closure. Mechanical compression springs are known to weaken over time, thus becoming less reliable and potentially needing replacement.

The overall trend in the petroleum industry over the last years has been to reduce manning on offshore oil & gas platforms, and to introduce UWPs with only yearly maintenance visits. However, HPUs, as included in hydraulic operation systems, require more frequent maintenance intervals to operate, which is not in line with the philosophy of unmanned facilities.

Lately, some operators have solved this problem by locating the HPU on a manned installation nearby and transporting the hydraulic fluid under pressure in a pipeline along the seabed to the unmanned facility. This may introduce the risk of potential oil leakage to sea in case of breakage of the pipeline. Also, the distance between the unmanned facility and the manned installation must be limited due to pressure losses along the way. The cost of such pipelines/umbilicals/hoses used for transport of pressurized hydraulics is significant.

U.S. Pat. No. 3,921,500A discloses a system for operating subsea hydraulically actuated devices such as subsea well control apparatus. The system provides for cycling of the hydraulic fluid continuously in a closed loop from a high pressure side from which the actuated device is energised to a low pressure side which receives hydraulic fluid discharged from the device. There is also provided a system for repressuring the discharged hydraulic fluid with a gas which may also be recycled in an independent closed loop. The repressurised hydraulic fluid is continuously recycled to function as the energy transmitting medium in the system.

U.S. Pat. No. 5,101,907A discloses a differential pressure actuating system for downhole tools. The system provides endless operation by the use of the differential pressure between two isolated zones of a well as a power source for the tool. The differential pressure is applied across a power transfer element to operate the downhole tool.

U.S. Pat. No. 7,614,454 B2 discloses a method for repeatably providing large operating forces to actuate a remote device in a well. There is disclosed a downhole pressure storage chamber, a valve communication between the pressure storage chamber and prevailing well pressure, a piston/cylinder device coupled with the remote device to actuator the latter, and an isolation valve for controlling the supply of pressure energy from the storage chamber to the piston/cylinder device. A method is disclosed which includes the steps of replenishably storing pressure in the storage chamber during the operating sequence, such stored pressure being derived from fluid flow permitted by the valve, and repeatably operating the isolation valve to apply differential pressure to the piston/cylinder device to actuate the remote device.

The invention has for its object to remedy or to reduce at least one of the drawbacks of the prior art, or at least provide a useful alternative to prior art.

The object is achieved through features, which are specified in the description below and in the claims that follow.

### SUMMARY

According to a first aspect of the invention, there is provided an actuator system for use with a safety critical valve, the actuator system comprising: a low-pressure accumulator comprising a first energy store and a first hydraulic fluid chamber; a high-pressure accumulator comprising a second energy store and a second hydraulic fluid chamber; a pump; a directional control valve configured to automatically move from a first position to a second position on loss of a control signal or electrical power; an actuator comprising a first port for receiving high-pressure hydraulic fluid to open the actuator and a second port for receiving high-pressure hydraulic fluid to close the actuator; a first hydraulic fluid connection between the pump and the second hydraulic fluid chamber, a second hydraulic fluid connection between the first hydraulic fluid chamber and the directional control valve, a third hydraulic fluid connection between the second hydraulic fluid chamber and the directional control valve; a fourth hydraulic fluid connection between the directional control valve and the first port of the actuator and a fifth hydraulic fluid connection between the directional control valve and the second port of the actuator; wherein in the first position the directional control valve provides fluid communication between the second hydraulic fluid chamber and the first port and fluid communication between the first hydraulic fluid chamber and the second port and in the second position the directional control valve provides fluid communication between the second hydraulic fluid chamber and the second port and fluid communication between the first hydraulic fluid chamber and the first port; wherein the pump is configured to provide pressurised hydraulic fluid from the first hydraulic fluid chamber to the second hydraulic fluid chamber to recharge the high-pressure accumulator such that if the control signal or electrical power is lost to the directional control valve in use, the directional control valve will automatically move to the first position and high-pressure hydraulic fluid will be provided from the second hydraulic fluid chamber to the second port to close the actuator.

According to a second aspect of the invention, there is provided an actuator system for use with a safety critical valve, the actuator system comprising: a low-pressure accumulator comprising a first energy store and a first hydraulic fluid chamber; a high-pressure accumulator comprising a second energy store and a second hydraulic fluid chamber; a pump; a directional control valve configured to automatically move from a first position to a second position on loss of a control signal or electrical power; an actuator comprising a first port for receiving high-pressure hydraulic fluid to close the actuator and a second port for receiving high-pressure hydraulic fluid to open the actuator; a first hydraulic fluid connection between the pump and the second hydraulic fluid chamber, a second hydraulic fluid connection between the first hydraulic fluid chamber and the directional control valve, a third hydraulic fluid connection between the second hydraulic fluid chamber and the directional control valve; a fourth hydraulic fluid connection between the directional control valve and the first port of the actuator and a fifth hydraulic fluid connection between the directional control valve and the second port of the actuator; wherein in the first position the directional control valve provides fluid communication between the second hydraulic fluid chamber and the first port and fluid communication between the first hydraulic fluid chamber and the second port and in the second position the directional control valve provides fluid communication between the second hydraulic fluid chamber and the second port and fluid communication between the first hydraulic fluid chamber and the first port; wherein the pump is configured to provide pressurised hydraulic fluid from the first hydraulic fluid chamber to the second hydraulic fluid chamber to recharge the high-pressure accumulator such that if the control signal or electrical power is lost to the directional control valve in use, the directional control valve will automatically move to the first position and high-pressure hydraulic fluid will be provided from the second hydraulic fluid chamber to the second port to open the actuator.

The first energy store may comprise a first compressible gas reservoir. The second energy store may comprise a second compressible gas reservoir.

The first energy store may comprises a first nitrogen gas reservoir. The second energy store may comprises a second nitrogen gas reservoir.

The first energy store and the first hydraulic fluid chamber may be separated by a first floating piston. There may be provided a first floating piston level transmitter configured to read and transmit the level of the first floating piston. The second energy store and the second hydraulic fluid chamber may be separated by a second floating piston. There may be provided a second floating piston level transmitter configured to read and transmit the level of the second floating piston.

The directional control valve may be configured to be moveable in use from the first position to the second position and from the second position to the first position.

The directional control valve may comprise a biassing member arranged to automatically move the directional control valve from a first position to a second position on loss of a control signal or electrical power. The biassing member may be a spring.

The directional control valve may be a four-way directional control valve or a 4/2 directional control valve.

The fourth hydraulic fluid connection may comprise a first flow control valve configured to allow adjustment of the time taken for the actuator to open.

The fifth hydraulic fluid connection may comprise a second flow control valve configured to allow adjustment of the time taken for the actuator to close.

The fourth hydraulic fluid connection may comprise a first pressure transmitter. The fifth hydraulic fluid connection may comprise a second pressure transmitter.

The actuator system may further comprise an actuator position transmitter configured to read and transmit the position of the actuator.

There may be provided a pressure limiter operatively connected to the second and third hydraulic fluid flow paths. The pressure limiter may be a relief valve.

There may be provided a pressure reducer operatively connected to the third hydraulic fluid connection and configured such that the pressure provided to the actuator does not exceed the maximum allowable stem torque.

The first hydraulic fluid connection may comprise a one-way valve arranged to only allow hydraulic fluid flow in the first hydraulic fluid connection from the first hydraulic fluid chamber to the second hydraulic fluid chamber.

The first hydraulic fluid connection may comprise a filter for filtering and cleaning the hydraulic fluid passing therethrough.

The second hydraulic fluid connection may comprise a back pressure limiter configured to protect the low-pressure accumulator from excessive pressure when the actuator is moved from the open position to the closed position.

The first energy store may be provided with a first energy store temperature transmitter configured to read and transmit the temperature in the first energy store. The first energy store may be provided with a first energy store pressure transmitter configured to read and transmit the pressure in the first energy store.

The second energy store may be provided with a second energy store temperature transmitter configured to read and transmit the temperature in the second energy store. The second energy store may be provided with a second energy store pressure transmitter configured to read and transmit the pressure in the second energy store.

The first hydraulic fluid chamber may be provided with a first hydraulic fluid chamber temperature transmitter configured to read and transmit the temperature in the first hydraulic fluid chamber. The first hydraulic fluid chamber may be provided with a third energy store pressure transmitter configured to read and transmit the pressure in the first energy store.

The second hydraulic fluid chamber may be provided with a second hydraulic fluid chamber temperature transmitter configured to read and transmit the temperature in the second hydraulic fluid chamber. The second hydraulic fluid chamber may be provided with a second hydraulic chamber pressure transmitter configured to read and transmit the pressure in the second hydraulic fluid chamber. The pump may be located in the first hydraulic fluid chamber.

The system may further comprise a sixth hydraulic fluid connection between the pump and the first hydraulic fluid chamber.

The low-pressure accumulator and the high-pressure accumulator may be provided within a double piston accumulator.

The pistons of the double piston accumulator may be connected internally within the double piston accumulator. The pistons within the double piston accumulator may be connected such that they move together.

According to a third aspect of the invention, there is provided a safety critical valve system, comprising: a safety critical valve configured to be moveable between an open position and a closed position; and the actuator system according to the first or second aspect of the invention; wherein the actuator is configured with the safety critical valve such that when the actuator is in the open position the safety critical valve is in the open position and when the actuator is in the closed position the safety critical valve is in the closed position.

According to a fourth aspect of the invention, there is provided a method of configuring an actuator system such that the actuator system will provide fail-safe closing on loss of a control signal or electrical power, the method comprising the steps of: providing an actuator system according to the first aspect of the invention; operating the pump to pump pressurised hydraulic fluid from the first hydraulic fluid chamber to the second hydraulic fluid chamber to charge the high-pressure accumulator; and moving the actuator to the open position.

According to a fifth aspect of the invention, there is provided a method of configuring an actuator system such that the actuator system will provide fail-safe opening on loss of a control signal or electrical power, the method comprising the steps of: providing an actuator system according to the second aspect of the invention; operating the pump to pump pressurised hydraulic fluid from the first hydraulic fluid chamber to the second hydraulic fluid chamber to charge the high-pressure accumulator; and moving the actuator to the closed position.

According to a sixth aspect of the invention, there is provided a method of operating an actuator system to provide fail-safe closing on loss of a control signal or electrical power, the method comprising the steps of: providing an actuator system according to the first aspect of the invention; operating the pump to pump pressurised hydraulic fluid from the first hydraulic fluid chamber to the second hydraulic fluid chamber to charge the high-pressure accumulator; moving the actuator to the open position; and stopping providing electrical power or a control signal to the directional control valve such that the actuator moves to the closed position automatically.

According to a seventh aspect of the invention, there is provided a method of operating an actuator system to provide fail-safe opening on loss of a control signal or electrical power, the method comprising the steps of: providing an actuator system according to the second aspect of the invention; operating the pump to pump pressurised hydraulic fluid from the first hydraulic fluid chamber to the second hydraulic fluid chamber to charge the high-pressure accumulator; moving the actuator to the closed position; and stopping providing electrical power or a control signal to the directional control valve such that the actuator moves to the open position automatically.

According to an eighth aspect of the invention, there is provided a method of configuring a safety critical valve system with fail-safe closing on loss of a control signal or electrical power, the method comprising the steps of: providing a safety critical valve system, comprising: a safety critical valve configured to be moveable between an open position and a closed position; and the actuator system according to the first aspect of the invention; wherein the actuator is configured with the safety critical valve such that when the actuator is in the open position the safety critical valve is in the open position and when the actuator is in the closed position the safety critical valve is in the closed position; operating the pump to pump pressurised hydraulic fluid from the first hydraulic fluid chamber to the second hydraulic fluid chamber to charge the high-pressure accumulator; and opening the valve by moving the actuator to the open position.

According to a ninth aspect of the invention, there is provided a method of configuring a safety critical valve system with fail-safe opening on loss of a control signal or electrical power, the method comprising the steps of: providing a safety critical valve system, comprising: a safety critical valve configured to be moveable between an open position and a closed position; and the actuator system according to the second aspect of the invention; wherein the actuator is configured with the safety critical valve such that when the actuator is in the open position the safety critical valve is in the open position and when the actuator is in the closed position the safety critical valve is in the closed position; operating the pump to pump pressurised hydraulic fluid from the first hydraulic fluid chamber to the second hydraulic fluid chamber to charge the high-pressure accumulator; and closing the valve by moving the actuator to the closed position.

According to a tenth aspect of the invention, there is provided a method of operating a safety critical valve system to provide fail-safe closing on loss of a control signal or electrical power, the method comprising the steps of: providing a safety critical valve system, comprising: a safety critical valve configured to be moveable between an open position and a closed position; and the actuator system according to the second aspect of the invention; wherein the actuator is configured with the safety critical valve such that when the actuator is in the open position the safety critical valve is in the open position and when the actuator is in the closed position the safety critical valve is in the closed position; operating the pump to pump pressurised hydraulic fluid from the first hydraulic fluid chamber to the second hydraulic fluid chamber to charge the high-pressure accumulator; moving the actuator to the open position; and automatically closing the valve by stopping providing electrical power or a control signal to the directional control valve such that the actuator moves to the closed position automatically.

According to a eleventh aspect of the invention, there is provided a method of operating a safety critical valve system to provide fail-safe opening on loss of a control signal or electrical power, the method comprising the steps of: providing a safety critical valve system, comprising: a safety critical valve configured to be moveable between an open position and a closed position; and the actuator system according to the second aspect of the invention; wherein the actuator is configured with the safety critical valve such that when the actuator is in the open position the safety critical valve is in the open position and when the actuator is in the closed position the safety critical valve is in the closed position; operating the pump to pump pressurised hydraulic fluid from the first hydraulic fluid chamber to the second hydraulic fluid chamber to charge the high-pressure accumulator; moving the actuator to the closed position; and automatically opening the valve by stopping providing electrical power or a control signal to the directional control valve such that the actuator moves to the open position automatically.

According to a twelfth aspect of the invention, there is provided an actuator kit for assembling an actuator system for use with a safety critical valve, the actuator kit comprising: a low-pressure module comprising a low-pressure accumulator; a high-pressure module comprising a high-pressure accumulator; a control module; and an actuator module; wherein the low-pressure accumulator comprises a first energy store and a first hydraulic fluid chamber comprising a pump, and the high-pressure accumulator comprises a second energy store and a second hydraulic fluid chamber; the control module comprises a directional control valve configured to automatically move from a first position to a second position on loss of a control signal or electrical power; the actuator module comprises an actuator comprising a first port for receiving high-pressure hydraulic fluid to open the actuator and a second port for receiving high-pressure hydraulic fluid to close the actuator; the low-pressure module and high-pressure module are configured to be fluidly couplable with the control module such that when coupled; a first hydraulic fluid connection is formed between the pump and the second hydraulic fluid chamber such that the pump can provide pressurised hydraulic fluid from the first hydraulic fluid chamber to the second hydraulic fluid chamber to recharge the high-pressure accumulator; a second hydraulic fluid connection is formed between the first hydraulic fluid chamber and the directional control valve; a third hydraulic fluid connection is formed between the second hydraulic fluid chamber and the directional control valve; the control module is configured to be fluidly couplable with the actuator module such that when coupled; a fourth hydraulic fluid connection is formed between the directional control valve and the first port of the actuator; and a fifth hydraulic fluid connection is formed between the directional control valve and the second port of the actuator; such that when the kit is assembled into an actuator system and is in use, if the control signal or electrical power is lost to the directional control valve, the directional control valve will automatically move to the first position and high-pressure hydraulic fluid will be provided from the second hydraulic fluid chamber to the second port to close the actuator.

According to a thirteenth aspect of the invention, there is provided an actuator kit for assembling an actuator system for use with a safety critical valve, the actuator kit comprising: a low-pressure module comprising a low-pressure accumulator; a high-pressure module comprising a high-pressure accumulator; a control module; and an actuator module; wherein the low-pressure accumulator comprises a first energy store and a first hydraulic fluid chamber comprising a pump, and the high-pressure accumulator comprises a second energy store and a second hydraulic fluid chamber; the control module comprises a directional control valve configured to automatically move from a first position to a second position on loss of a control signal or electrical power; the actuator module comprises an actuator comprising a first port for receiving high-pressure hydraulic fluid to close the actuator and a second port for receiving high-pressure hydraulic fluid to open the actuator; the low-pressure module and high-pressure module are configured to be fluidly couplable with the control module such that when coupled; a first hydraulic fluid connection is formed between the pump and the second hydraulic fluid chamber such that the pump can provide pressurised hydraulic fluid from the first hydraulic fluid chamber to the second hydraulic fluid chamber to recharge the high-pressure accumulator; a second hydraulic fluid connection is formed between the first hydraulic fluid chamber and the directional control valve; a third hydraulic fluid connection is formed between the second hydraulic fluid chamber and the directional control valve; the control module is configured to be fluidly couplable with the actuator module such that when coupled; a fourth hydraulic fluid connection is formed between the directional control valve and the first port of the actuator; and a fifth hydraulic fluid connection is formed between the directional control valve and the second port of the actuator; such that when the kit is assembled into an actuator system and is in use, if the control signal or electrical power is lost to the directional control valve, the directional control valve will automatically move to the first position and high-pressure hydraulic fluid will be provided from the second hydraulic fluid chamber to the second port to open the actuator.

The first energy store may comprise a first compressible gas reservoir. The second energy store may comprise a second compressible gas reservoir.

The first energy store may comprises a first nitrogen gas reservoir. The second energy store may comprises a second nitrogen gas reservoir.

The first energy store and the first hydraulic fluid chamber may be separated by a first floating piston. The second energy store and the second hydraulic fluid chamber may be separated by a second floating piston.

The directional control valve may be configured to be moveable in use from the first position to the second position. The directional control valve may be configured to be moveable in use from the second position to the first position.

The directional control valve may comprise a biassing member arranged to automatically move the directional control valve from a first position to a second position on loss of a control signal or electrical power. The biassing member may be a spring.

The directional control valve may be a four-way directional control valve or a 4/2 directional control valve.

The low-pressure module may comprise one or more one-way valves which are arranged such that hydraulic fluid may not leak out of the low-pressure module when the low-pressure module is not connected to the control module.

The control module may comprise one or more one-way valves which are arranged such that hydraulic fluid may not leak out of the control module when the control module is not connected to the low-pressure module.

The one-way valves may be arranged in a stabbing configuration such that when the low-pressure module is stabbed into the control module, the one-way valves are opened and fluid communication in both directions is possible.

The high-pressure module may comprise one or more one-way valves arranged such that hydraulic fluid may not leak out of the high-pressure module when the high-pressure module is not connected to the control module. The control module may comprise one or more one-way valves arranged such that hydraulic fluid may not leak out of the control module when the control module is not connected to the high-pressure module. The one-way valves may be arranged in a stabbing configuration such that when the high-pressure module is stabbed into the control module, the one-way valves are opened and fluid communication in both directions is possible.

According to a fourteenth aspect of the invention, there is provided an actuator kit for assembling an actuator system for use with a safety critical valve, the actuator kit comprising: a pressurisation module comprising a double piston accumulator; a control module; and an actuator module; wherein the double piston accumulator comprises a low-pressure accumulator and a high-pressure accumulator; the low-pressure accumulator comprises a first energy store and a first hydraulic fluid chamber comprising a pump, and the high-pressure accumulator comprises a second energy store and a second hydraulic fluid chamber; the control module comprises a directional control valve configured to automatically move from a first position to a second position on loss of a control signal or electrical power; the actuator module comprises an actuator comprising a first port for receiving high-pressure hydraulic fluid to open the actuator and a second port for receiving high-pressure hydraulic fluid to close the actuator; the pressurisation module is configured to be fluidly couplable with the control module such that when coupled; a first hydraulic fluid connection is formed between the pump and the second hydraulic fluid chamber such that the pump can provide pressurised hydraulic fluid from the first hydraulic fluid chamber to the second hydraulic fluid chamber to recharge the high-pressure accumulator; a second hydraulic fluid connection is formed between the first hydraulic fluid chamber and the directional control valve; a third hydraulic fluid connection is formed between the second hydraulic fluid chamber and the directional control valve; the control module is configured to be fluidly couplable with the actuator module such that when coupled; a fourth hydraulic fluid connection is formed between the directional control valve and the first port of the actuator; and a fifth hydraulic fluid connection is formed between the directional control valve and the second port of the actuator; such that when the kit is assembled into an actuator system and is in use, if the control signal or electrical power is lost to the directional control valve, the directional control valve will automatically move to the first position and high-pressure hydraulic fluid will be provided from the second hydraulic fluid chamber to the second port to close the actuator.

According to a fifteenth aspect of the invention, there is provided an actuator kit for assembling an actuator system for use with a safety critical valve, the actuator kit comprising: a pressurisation module comprising a double piston accumulator; a control module; and an actuator module; wherein the double piston accumulator comprises a low-pressure accumulator and a high-pressure accumulator; the low-pressure accumulator comprises a first energy store and a first hydraulic fluid chamber comprising a pump, and the high-pressure accumulator comprises a second energy store and a second hydraulic fluid chamber; the control module comprises a directional control valve configured to automatically move from a first position to a second position on loss of a control signal or electrical power; the actuator module comprises an actuator comprising a first port for receiving high-pressure hydraulic fluid to close the actuator and a second port for receiving high-pressure hydraulic fluid to open the actuator; the pressurisation module is configured to be fluidly couplable with the control module such that when coupled; a first hydraulic fluid connection is formed between the pump and the second hydraulic fluid chamber such that the pump can provide pressurised hydraulic fluid from the first hydraulic fluid chamber to the second hydraulic fluid chamber to recharge the high-pressure accumulator; a second hydraulic fluid connection is formed between the first hydraulic fluid chamber and the directional control valve; a third hydraulic fluid connection is formed between the second hydraulic fluid chamber and the directional control valve; the control module is configured to be fluidly couplable with the actuator module such that when coupled; a fourth hydraulic fluid connection is formed between the directional control valve and the first port of the actuator; and a fifth hydraulic fluid connection is formed between the directional control valve and the second port of the actuator; such that when the kit is assembled into an actuator system and is in use, if the control signal or electrical power is lost to the directional control valve, the directional control valve will automatically move to the first position and high-pressure hydraulic fluid will be provided from the second hydraulic fluid chamber to the second port to open the actuator.

The first energy store may comprise a first compressible gas reservoir. The second energy store may comprise a second compressible gas reservoir.

The first energy store may comprises a first nitrogen gas reservoir. The second energy store may comprises a second nitrogen gas reservoir.

The first energy store and the first hydraulic fluid chamber may be separated by a first floating piston. The second energy store and the second hydraulic fluid chamber may be separated by a second floating piston.

The directional control valve may be configured to be moveable in use from the first position to the second position. The directional control valve may be configured to be moveable in use from the second position to the first position.

The directional control valve may comprise a biassing member arranged to automatically move the directional control valve from a first position to a second position on loss of a control signal or electrical power. The biassing member may be a spring.

The directional control valve may be a four-way directional control valve or a 4/2 directional control valve.

The pressurisation module may comprise one or more one-way valves which are arranged such that hydraulic fluid may not leak out of the pressurisation module when the pressurisation module is not connected to the control module.

The control module may comprise one or more one-way valves which are arranged such that hydraulic fluid may not leak out of the control module when the control module is not connected to the pressurisation module.

The one-way valves may be arranged in a stabbing configuration such that when the pressurisation module is stabbed into the control module, the one-way valves are opened and fluid communication in both directions is possible.

According to a sixteenth aspect of the invention, there is provided an actuator kit for assembling an actuator system for use with a safety critical valve, the actuator kit comprising: a pressurisation module comprising: a pump; and a double piston accumulator comprising a low-pressure accumulator and a high-pressure accumulator; a control module; and an actuator module; wherein the low-pressure accumulator comprises a first energy store and a first hydraulic fluid chamber, and the high-pressure accumulator comprises a second energy store and a second hydraulic fluid chamber; the pressurisation module further comprises a first hydraulic fluid connection between the pump and the second hydraulic fluid chamber such that the pump can provide pressurised hydraulic fluid from the first hydraulic fluid chamber to the second hydraulic fluid chamber to recharge the high-pressure accumulator; the control module comprises a directional control valve configured to automatically move from a first position to a second position on loss of a control signal or electrical power; the actuator module comprises an actuator comprising a first port for receiving high-pressure hydraulic fluid to open the actuator and a second port for receiving high-pressure hydraulic fluid to close the actuator; the pressurisation module is configured to be fluidly couplable with the control module such that when coupled; a second hydraulic fluid connection is formed between the first hydraulic fluid chamber and the directional control valve; a third hydraulic fluid connection is formed between the second hydraulic fluid chamber and the directional control valve; the control module is configured to be fluidly couplable with the actuator module such that when coupled; a fourth hydraulic fluid connection is formed between the directional control valve and the first port of the actuator; and a fifth hydraulic fluid connection is formed between the directional control valve and the second port of the actuator; such that when the kit is assembled into an actuator system and is in use, if the control signal or electrical power is lost to the directional control valve, the directional control valve will automatically move to the first position and high-pressure hydraulic fluid will be provided from the second hydraulic fluid chamber to the second port to close the actuator.

According to a seventeenth aspect of the invention, there is provided an actuator kit for assembling an actuator system for use with a safety critical valve, the actuator kit comprising: a pressurisation module comprising: a pump; and a double piston accumulator comprising a low-pressure accumulator and a high-pressure accumulator; a control module; and an actuator module; wherein the low-pressure accumulator comprises a first energy store and a first hydraulic fluid chamber, and the high-pressure accumulator comprises a second energy store and a second hydraulic fluid chamber; the pressurisation module further comprises a first hydraulic fluid connection between the pump and the second hydraulic fluid chamber such that the pump can provide pressurised hydraulic fluid from the first hydraulic fluid chamber to the second hydraulic fluid chamber to recharge the high-pressure accumulator; the control module comprises a directional control valve configured to automatically move from a first position to a second position on loss of a control signal or electrical power; the actuator module comprises an actuator comprising a first port for receiving high-pressure hydraulic fluid to close the actuator and a second port for receiving high-pressure hydraulic fluid to open the actuator; the pressurisation module is configured to be fluidly couplable with the control module such that when coupled; a second hydraulic fluid connection is formed between the first hydraulic fluid chamber and the directional control valve; a third hydraulic fluid connection is formed between the second hydraulic fluid chamber and the directional control valve; the control module is configured to be fluidly couplable with the actuator module such that when coupled; a fourth hydraulic fluid connection is formed between the directional control valve and the first port of the actuator; and a fifth hydraulic fluid connection is formed between the directional control valve and the second port of the actuator; such that when the kit is assembled into an actuator system and is in use, if the control signal or electrical power is lost to the directional control valve, the directional control valve will automatically move to the first position and high-pressure hydraulic fluid will be provided from the second hydraulic fluid chamber to the second port to open the actuator.

The first energy store may comprise a first compressible gas reservoir. The second energy store may comprise a second compressible gas reservoir.

The first energy store may comprises a first nitrogen gas reservoir. The second energy store may comprises a second nitrogen gas reservoir.

The first energy store and the first hydraulic fluid chamber may be separated by a first floating piston. The second energy store and the second hydraulic fluid chamber may be separated by a second floating piston.

The directional control valve may be configured to be moveable in use from the first position to the second position. The directional control valve may be configured to be moveable in use from the second position to the first position.

The directional control valve may comprise a biassing member arranged to automatically move the directional control valve from a first position to a second position on loss of a control signal or electrical power. The biassing member may be a spring.

The directional control valve may be a four-way directional control valve or a 4/2 directional control valve.

The pressurisation module may comprise one or more one-way valves which are arranged such that hydraulic fluid may not leak out of the pressurisation module when the pressurisation module is not connected to the control module.

The control module may comprise one or more one-way valves which are arranged such that hydraulic fluid may not leak out of the control module when the control module is not connected to the pressurisation module.

The one-way valves may be arranged in a stabbing configuration such that when the pressurisation module is stabbed into the control module, the one-way valves are opened and fluid communication in both directions is possible.

### BRIEF DESCRIPTION OF THE DRAWINGS

An embodiment of the invention will now be described with reference to the following drawings, in which:

FIG. 1 shows a hydraulics diagram of an actuator assembly in accordance with the present invention; and

FIG. 2 shows a detailed view of the actuator of the actuator assembly of FIG. 1 in the closed position;

FIG. 3 shows a detailed view of the actuator of the actuator assembly of FIG. 1 in the open position;

FIG. 4 shows a hydraulics diagram of an alternative actuator assembly in accordance with the present invention;

FIG. 5 shows a detailed view of the actuator of the actuator assembly of FIG. 4 in the closed position; and

FIG. 6 shows a detailed view of the actuator of the actuator assembly of FIG. 4 in the open position.

For clarity reasons, some elements may in some of the figures be without reference numerals. A person skilled in the art will understand that the figures are just principal drawings. The relative proportions of individual elements may also be distorted.

### DETAILED DESCRIPTION OF THE DRAWINGS

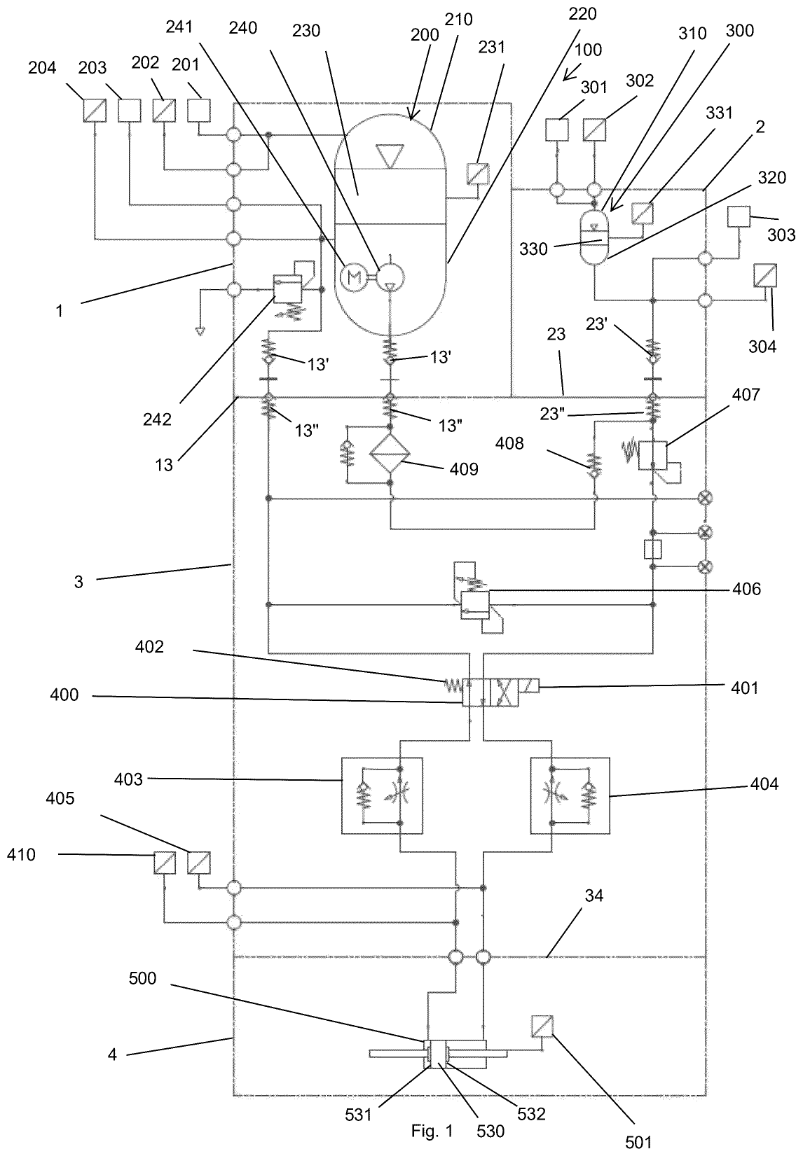

FIG. 1 shows an actuator assembly 100 comprising many components. In the interest of clarity, the main components of the actuator assembly 100 are described firstly, with further details provided later. It will be understood that some details of the assembly 100 will be omitted in the interest of clarity and brevity, as it is regarded that the suitable arrangement, configuration and connection of minor components in the actuator assembly 100 not recited herein is well within the capabilities of a person skilled in the art.

The actuator assembly 100 is modular and comprises a low-pressure module 1, a high-pressure module 2, a control module 3 and an actuator module 4. The actuator assembly 100 shown in FIG. 1 is provided such that each module 1, 2, 3, 4 can be separated and detached from the remaining modules for servicing, maintenance and ease of assembly. The actuator assembly 100 is shown in the assembled configuration in FIG. 1. The actuator assembly 100 may be provided with a protective cover enclosing the entire actuator assembly 100 or parts thereof for protection from dirt or fluid ingress and for easy handling. Further details of the modular nature of the assembly 100 will be described in more detail later.

The actuator assembly 100 is configured to be mountable directly onto a valve (not shown) such that the actuator assembly 100 can control (i.e. mechanically open and close) the valve with only connection to an operator (which may simply be a computer or control system) for communications with the actuator assembly and the provision of electrical power.

The actuator assembly 100 comprises main components of a low-pressure accumulator 200, a high-pressure accumulator 300, a directional control valve 400 and an actuator 500 movable between an open position (such that the valve is in an open position to allow fluid flow therethrough) and a closed position (such that the valve is in a closed position to block fluid flow therethrough).

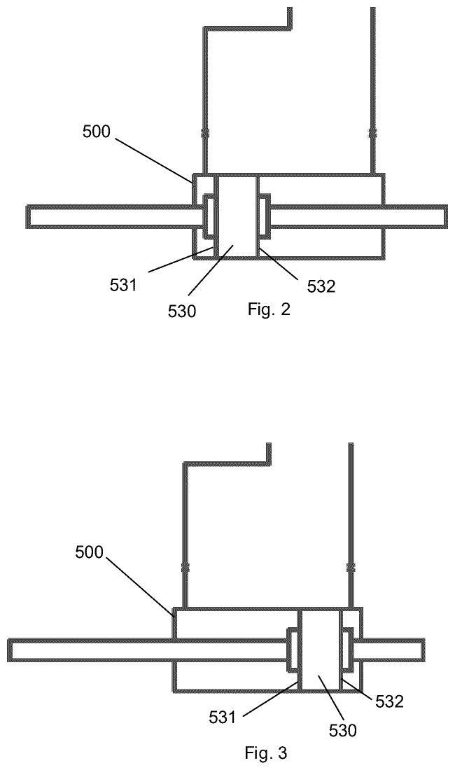

In FIG. 1, the actuator 500 is shown in a closed position. The actuator 500 is provided with an actuator piston 530 configured such that pressurised fluid may be applied to the piston 530 to move the actuator between the closed position and an open position, and vice versa. Referring briefly to FIGS. 2 and 3, the piston 530 has a first side 531 and a second side 532, such that pressurised fluid can be applied to the first side 531 to move the actuator 500 from the closed position shown in FIG. 2 to the open position shown in FIG. 3, and pressurised fluid can be applied to the second side 532 to move the actuator 500 from the open position shown in FIG. 3 to the closed position shown in FIG. 2.

Referring again to FIG. 1, the main components of the actuator assembly 100 are connected by hydraulic connections such that hydraulic fluid may flow therebetween in operation of the actuator assembly 100. In this connection, in the closed position shown in FIG. 1, the low-pressure accumulator 200 is fluidly connected to the first side 531 of the actuator 500 and the high-pressure accumulator 300 is fluidly connected to the second side 532 of the actuator 500. The high-pressure accumulator 300 is therefore providing pressurised hydraulic fluid to keep the actuator 500 in the closed position.

The low-pressure accumulator 200 is fluidly connected to the high-pressure accumulator 300 such that the low-pressure accumulator 200 can be used to charge the high-pressure accumulator 300 when required, as will be explained later.

Still referring to FIG. 1, the low-pressure accumulator 200 is divided into a first upper chamber 210 and a first lower chamber 220 by a first floating piston 230. The high-pressure accumulator 300 is similarly divided into a second upper chamber 310 and a second lower chamber 320 by second floating piston 330. The first 210 and second 310 upper chambers comprise nitrogen gas and the first 220 and second 320 lower chambers comprise a hydraulic fluid.

Nitrogen gas is used as the compressible medium within which energy is stored in the system. Nitrogen is selected because it is inert and has a linear compression curve providing a stable and reliable compressible fluid. A mechanical spring or other fluids could replace nitrogen gas but a mechanical spring would typically degrade over time and become less efficient. It is also likely that a mechanical spring would need servicing and/or replacing more regularly, therefore nitrogen gas is preferred.

The hydraulic fluid is preferably an environmentally friendly liquid with stable viscosity. In the presently described example, a branded product sold under the Trademark “Shell Naturelle” is used, which is a lithium complex grease designed for extreme pressure with anti-oxidant, anti-wear and anti-rust protection across a wide temperature range. It will be understood that other suitable hydraulic fluids, and preferably environmentally friendly hydraulic fluids, with stable viscosity will be known to the person skilled in the art and may be used instead of “Shell Naturelle”.

Still referring to FIG. 1, it can be seen that the first lower chamber 220 comprises a pump 240 operatively connected to an electrical motor 241 to drive the pump 240 when required. The pump 240 has the function of charging the high-pressure accumulator 300, as will be described in more detail later. In normal operation, the valve (not shown) is held open by pressure from the high-pressure accumulator 300 which holds the actuator 500 in the open position. The actuator 500 may be held in the open position without any electrical power as the hydraulic fluid in the second lower chamber 320 and connection to the first side 531 of the piston 530 is within a closed system such that once the fluid is pressurised it will remain pressurised on the first face 531, thereby holding the actuator 500 in the open position. The actuator 500 is closed by use of the high-pressure accumulator 300 providing high pressure to the second side 532 of the piston 500. This is done by switching the high-pressure hydraulic fluid path from providing high pressure fluid from the high-pressure accumulator 300 to the first side 531 to providing high pressure fluid from the high-pressure accumulator 300 to the second side 532, by use of the directional control valve 400 as is now explained.

The directional control valve 400 in the presently described example is in the form of a four-way solenoid valve. The directional control valve 400 can be put into a first position or a second position. Such a valve is also occasionally referred to as a 4/2 directional control valve. In use, the directional control valve 400 can move between the first and second position.

In the first position (not shown), the directional control valve 400 provides fluid communication between the high-pressure accumulator 300 and the first side 531 of the actuator 500, and fluid communication between the low-pressure accumulator 300 and the second side 532 of the actuator 500. In the second position, the directional control valve 400 provides fluid communication between the high-pressure accumulator 300 and the second side 532 of the actuator 500 and fluid communication between the low-pressure accumulator 300 and the first 531 of the actuator 500.

In this regard, in the first position, the high-pressure accumulator 300 can provide pressurised fluid to the first side 531, while fluid at the second side 532 does not create a hydraulic lock as it can be released/bled off to the low-pressure accumulator 200, whereby the hydraulic fluid is maintained in a closed loop.

Similarly, in the second position (shown in FIG. 1), the high-pressure accumulator 300 can provide pressurised fluid to the second side 532, while fluid at the first side 531 does not create a hydraulic lock as it can be released/bled off to the low-pressure accumulator 200, whereby the hydraulic fluid is maintained in a closed loop.

To allow the directional control valve 400 to move between the first position and the second position, a solenoid 401 is arranged with a spring 402. The solenoid 401 and spring 402 together provide operation of the directional control valve 400. When the solenoid 401 is powered, the solenoid 401 pushes against the spring 402 and maintains the directional control valve 400 in the first position (not shown), that is the directional control valve 400 providing fluid communication between the high-pressure accumulator 300 and the first side 531 of the actuator 500. When power is lost to the solenoid 401, the spring 402 automatically pushes the solenoid 401 and thereby moves the directional control valve 400 to the second position (shown in FIG. 1), that is the directional control valve 400 providing fluid communication between the high-pressure accumulator 200 and the second side 532 of the actuator 500. When the directional control valve 400 is in this second position, high-pressure fluid from the high-pressure accumulator 300 is communicated to the second side 532 of the piston 530, thereby moving the actuator 500 to the closed position. The directional control valve 400 is controlled by a safety automation system (which may be located remote from the actuator assembly 100).

The pump 240 functions to pump hydraulic fluid from the low-pressure accumulator 200 to the high-pressure accumulator 300 to recharge the high-pressure accumulator 300.

It will be understood that the first floating piston 230 and second floating piston 330 allow the nitrogen gas in the first upper chamber 210 and second upper chamber 310 to be compressed to store energy. The nitrogen gas can be allowed to expand again to release the stored energy, thereby moving the floating pistons 230, 330.

The actuator assembly 100 starts operation in a stand-by mode with the actuator 500 closed initially (as shown in FIG. 1) and the directional control valve 400 providing fluid communication between the high-pressure accumulator 300 and the second side 532 of the actuator 500. The high-pressure accumulator 300 is charged with pressurised hydraulic fluid of four times the valve closure capacity. Depending on the type of operation one, two, three, five or more time the valve closure capacity may be desirable or required. The high-pressure accumulator 300 is charged with pressurised hydraulic fluid of four times the valve closure capacity, such that if required, the high-pressure accumulator 300 could deliver high-pressure hydraulic fluid to the second side 532 of the piston 530 to close the actuator 500 up to four times without being re-charged from the pump 240 in the low-pressure accumulator 200. This also ensures that once the high-pressure accumulator 300 has been used to move the actuator 500 to the open position, there is sufficient pressurised fluid in the high-pressure accumulator 300 to close the actuator 500 again immediately, if required.

In this connection, once the high-pressure accumulator 300 has been sufficiently charged in the stand-by mode, the actuator assembly 100 can be moved to an operational mode. In the operational mode the directional control valve 400 is powered and the solenoid 401 is moved to move the directional control valve 400 from the second position (shown in FIG. 1) to the first position where the directional control valve 400 provides fluid communication between the high-pressure accumulator 300 and the first side 531 of the actuator 500, and fluid communication between the low-pressure accumulator 300 and the second side 532 of the actuator 500. The directional control valve 400 will receive a communication signal from the safety automation system to stay in the operational mode.

If power to the directional control valve 400 is lost, or there is a malfunction or loss of communication signal from the safety automation system, the actuator assembly 100 enters a fail-safe closing mode. In the fail-safe closing mode the solenoid 401 is no longer actively powered and is therefore moved by the spring 402 automatically such that the directional control valve 400 returns automatically to the second position shown in FIG. 1. Once the actuator 500 has fully closed, the actuator assembly 100 returns to stand-by mode where the actuator 500 and so the valve, are held in the closed position by the remaining force after the actuator 500 has been closed, without the need for consumption of electrical energy in this closed position. The actuator assembly 100 then starts the above cycle again by recharging the high-pressure accumulator 300 with pressurised hydraulic fluid of four times the valve closure capacity and once the high-pressure accumulator 300 has been sufficiently charged in the stand-by mode, the actuator assembly 100 can be moved to an operational mode as previously described.

Standards may require that the system shall be provided with sufficient back-up power to close the valve three or four or more times without the supply of external power.

Referring again to FIG. 1, further details of the preferred embodiment shown are now provided which allow safe and reliable operation of the actuator assembly 100. The inclusion of some components will be self-explanatory to a person skilled in the art, and therefore such components are not explained in detail in the interest of brevity.

In the preferred embodiment shown, the actuator assembly 100 comprises a first flow control valve 403 connected between the directional control valve 400 and the actuator 500 and configured to allow adjustment of the time taken for the valve to open, and a second flow control valve 404 connected between the directional control valve 400 and the actuator 500 and configured to allow adjustment of the time taken for the valve to close. In this connection, between the first flow control valve 403 and the actuator 500 there is provided a first pressure transmitter 410, and between the second flow control valve 404 and the actuator 500 there is provided a second pressure transmitter 405.

There is also provided an actuator position transmitter 501 configured to read and transmit the position of the actuator 500 to allow confirmation that the actuator 500 is in the desired position. Similarly, the low-pressure accumulator 200 and high-pressure accumulator 300 are provided with a first floating piston level transmitter 231 and a second floating piston level transmitter 331, respectively. The first and second floating piston level transmitters 231, 331 are configured to read and transmit the level of the first floating piston 230 and second floating piston 330, respectively.

There is also provided a pressure limiter 406 in the form of a relief valve. The pressure limiter 406 is operatively connected to the hydraulic fluid flow paths leading from the low-pressure accumulator 200 and the high-pressure accumulator 300 towards the actuator 500, such that the maximum system pressure will not be exceed a determined threshold value. Exceeding the determined threshold value could cause damage to the actuator 500, therefore excessively high pressures are released via the pressure limiter 406. Similarly, a pressure reducer 407 is operatively connected to the hydraulic flow path leading from the high-pressure accumulator 300 towards the actuator 500 to ensure that the pressure provided to the actuator 500 does not exceed the maximum allowable stem torque. If the maximum allowable stem torque of the valve were to be exceeded, the valve to be operated by the actuator 500 may be damaged.

Still referring to FIG. 1, there is also provided a one-way valve 408 arranged to only allow hydraulic fluid flow from the low-pressure accumulator 200 to the high-pressure accumulator 300 and not from the high-pressure accumulator 300 to the low-pressure accumulator 200. Additionally, in the same line as the one-way valve 408, i.e. the connection between the low-pressure accumulator 200 and the high-pressure accumulator 300, there is provided a filter 409 for filtering and cleaning the hydraulic fluid.

Referring again to the connection between the low-pressure accumulator 200 and the actuator 500 there is provided a back pressure limiter 242 which is configured to protect the low-pressure accumulator 200 from excessive pressure when the actuator 500 is moved from the open position to the closed position, thereby potentially creating an excessive back pressure in the connection between the low-pressure accumulator 200 and the actuator 500.

There is also provided a first upper chamber temperature transmitter 201 and a first upper chamber pressure transmitter 202 which are configured to read and transmit the temperature in the first upper chamber 210 and the pressure in the first upper chamber 210, respectively.

Similarly, there is provided a first lower chamber temperature transmitter 203 and a first lower chamber pressure transmitter 204 which are configured to read and transmit the pressure in the first lower chamber 220 and the temperature in the first lower chamber 220, respectively.

Similarly, there is provided a second upper chamber temperature transmitter 301 and a second upper chamber pressure transmitter 302 which are configured to read and transmit the temperature in the second upper chamber 310 and the pressure in the second upper chamber 310, respectively.

Similarly, there is provided a second lower chamber temperature transmitter 303 and a second lower chamber pressure transmitter 304 which are configured to read and transmit the temperature in the second lower chamber 320 and the pressure in the second lower chamber 320, respectively.

Still referring to FIG. 1, it can be seen that the low-pressure module 1 is connected to the control module 3 at a first connection 13. The low-pressure module 1 comprises first one-way valves 13′ which are arranged such that hydraulic fluid may not leak out of the low-pressure module 1 when the low-pressure module 1 is not connected to the control module 3. Similarly, the control module comprises second one-way valves 13″ which are arranged such that hydraulic fluid may not leak out of the control module 3 when the control module 3 is not connected to the low-pressure module 1. The first and second one-way valves 13′, 13″ are arranged in a stabbing configuration such that when the low-pressure module 1 is stabbed into the control module 3, the one-way valves are opened and fluid communication in both directions is possible.

Similarly, the high-pressure module 2 is connected to the control module 3 at a second connection 23. The high-pressure module 2 comprises a third one-way valve 23′ arranged such that hydraulic fluid may not leak out of the high-pressure module 2 when the high-pressure module 2 is not connected to the control module 3. Similarly, the control module 3 comprises a fourth one-way valve 23″ arranged such that hydraulic fluid may not leak out of the control module 3 when the control module 3 is not connected to the high-pressure module 2. The third and fourth one-way valves 23′, 23″ are arranged in a stabbing configuration such that when the high-pressure module 2 is stabbed into the control module 3, the one-way valves 23′, 23″ are opened and fluid communication in both directions is possible.

The actuator module 4 is releasably connectable to the control module 3 via a third connection 34. The modular arrangement provided avoids the use of external tubing to connect components and minimises the number of potential leak points in the assembly 100. Furthermore, handling of the actuator assembly 100 as well as assembly and disassembly is simplified and the time required for each is reduced.

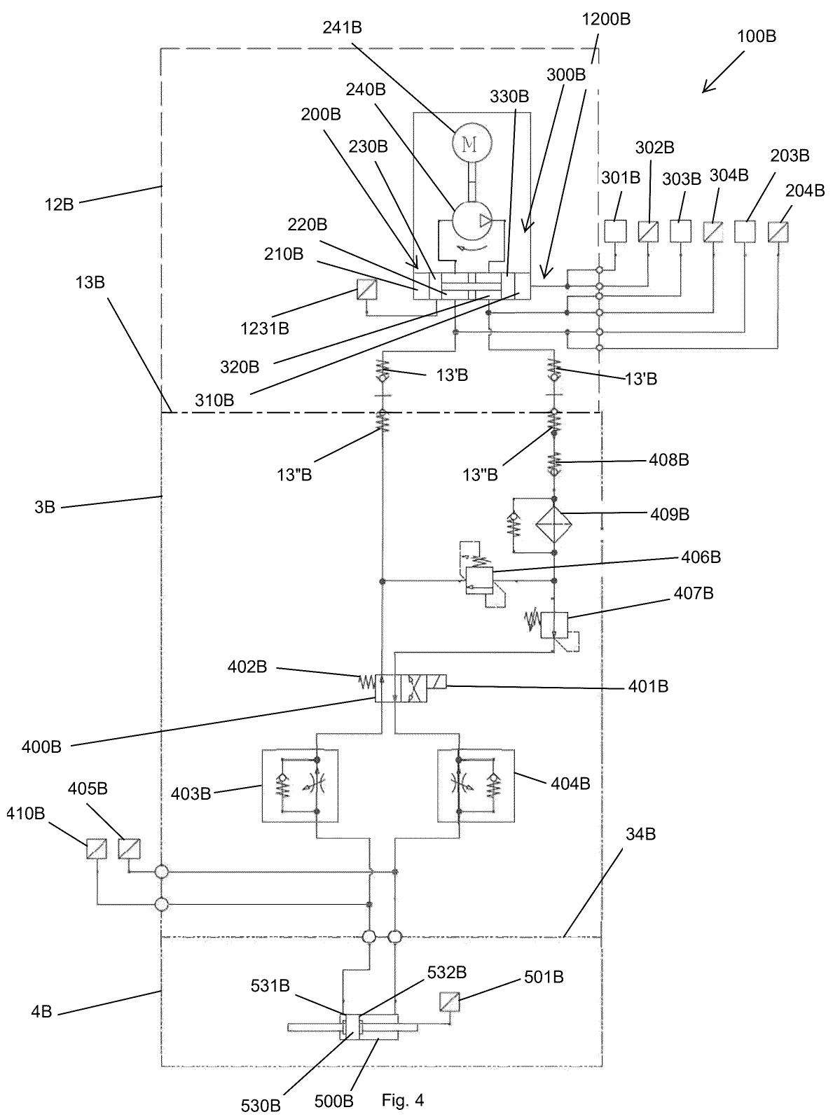

FIG. 4 shows an alternative actuator assembly 100B comprising many components. In the interest of clarity, the main components of the actuator assembly 100B are described firstly, with further details provided later. It will be understood that some details of the assembly 100B will be omitted in the interest of clarity and brevity, as it is regarded that the suitable arrangement, configuration and connection of minor components in the actuator assembly 100B not recited herein is well within the capabilities of a person skilled in the art.

Similarly to the actuator assembly 100 shown in FIG. 1, the actuator assembly 100B is modular and comprises a pressurisation module 12B, a control module 3B and an actuator module 4B. The actuator assembly 100B shown in FIG. 4 is provided such that each module 12B, 3B, 4B can be separated and detached from the remaining modules for servicing, maintenance and ease of assembly. The actuator assembly 100B is shown in the assembled configuration in FIG. 4. The actuator assembly 100B may be provided with a protective cover enclosing the entire actuator assembly 100B or parts thereof for protection from dirt or fluid ingress and for easy handling. Further details of the modular nature of the assembly 100B will be described in more detail later.

The actuator assembly 100B is configured to be mountable directly onto a valve (not shown) such that the actuator assembly 100B can control (i.e. mechanically open and close) the valve with only connection to an operator (which may simply be a computer or control system) for communications with the actuator assembly and the provision of electrical power.

The actuator assembly 100B comprises a double piston accumulator 1200B comprising a low-pressure accumulator 200B and a high-pressure accumulator 300B. In the previously described embodiment shown in FIG. 1, the low-pressure accumulator 200 and high-pressure accumulator 300 are separate components. That is to say, as previously described with reference to FIG. 1, the low-pressure accumulator 200 has a first floating piston 230 and the high-pressure accumulator 300 has a second floating piston 330. The first and second floating pistons 230, 330 are not directly connected in that they are each free to move irrespective of the other. In this connection, to monitor the position of the floating pistons 230, 330, as explained previously, the first and second floating piston level transmitters 231, 331 are configured to read and transmit the level of the first floating piston 230 and second floating piston 330, respectively.

The double piston accumulator 1200B provides the advantage of reducing the number of components required in the assembly 100B. More particularly, the double piston accumulator 1200B provides the advantage of reducing the number of sensors and transmitters required in the assembly 100B, as will be explained later.

The actuator assembly 100B further comprises a directional control valve 400B and an actuator 500B movable between an open position (such that the valve is in an open position to allow fluid flow therethrough) and a closed position (such that the valve is in a closed position to block fluid flow therethrough).

In FIG. 4, the actuator 500B is shown in a closed position. The actuator 500B is provided with an actuator piston 530B configured such that pressurised fluid may be applied to the piston 530B to move the actuator 500B between the closed position and an open position, and vice versa.

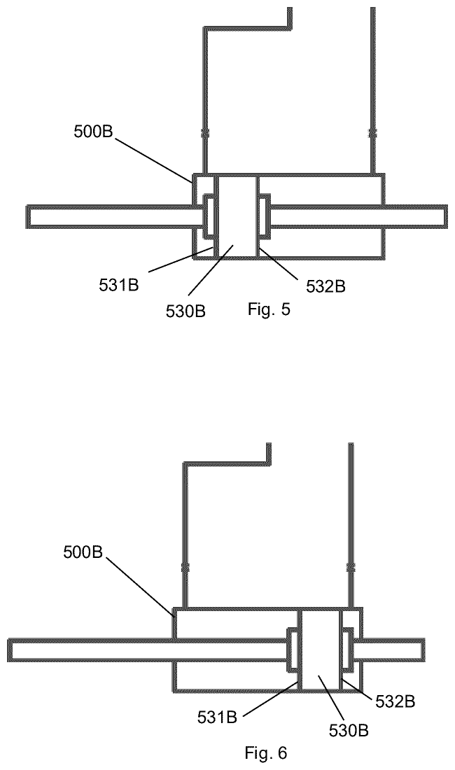

Referring briefly to FIGS. 5 and 6, the piston 530B has a first side 531B and a second side 532B, such that pressurised fluid can be applied to the first side 531B to move the actuator 500B from the closed position shown in FIG. 5 to the open position shown in FIG. 6, and pressurised fluid can be applied to the second side 532B to move the actuator 500B from the open position shown in FIG. 6 to the closed position shown in FIG. 5.

Referring again to FIG. 4, the main components of the actuator assembly 100B are connected by hydraulic connections such that hydraulic fluid may flow therebetween in operation of the actuator assembly 100B. In this connection, in the closed position shown in FIG. 4, the low-pressure accumulator 200B is fluidly connected to the first side 531B of the actuator 500B and the high-pressure accumulator 300B is fluidly connected to the second side 532B of the actuator 500B. The high-pressure accumulator 300A is therefore providing pressurised hydraulic fluid to keep the actuator 500B in the closed position.

The low-pressure accumulator 200B is fluidly connected to the high-pressure accumulator 300B such that the low-pressure accumulator 200B can be used to charge the high-pressure accumulator 300B when required, as will be explained later.

Still referring to FIG. 4, the low-pressure accumulator 200B is divided into a first outer chamber 210B and a first inner chamber 220B by a first piston 230B. The high-pressure accumulator 300B is similarly divided into a second outer chamber 310B and a second inner chamber 320B by a second piston 330B.

The first 210B and second 310B outer chambers comprise nitrogen gas and the first 220B and second 320B inner chambers comprise a hydraulic fluid.

Nitrogen gas is used as the compressible medium within which energy is stored in the system. Nitrogen is selected because it is inert and has a linear compression curve providing a stable and reliable compressible fluid. A mechanical spring or other fluids could replace nitrogen gas but a mechanical spring would typically degrade over time and become less efficient. It is also likely that a mechanical spring would need servicing and/or replacing more regularly, therefore nitrogen gas is preferred.

The hydraulic fluid is preferably an environmentally friendly liquid with stable viscosity. In the presently described example, a branded product sold under the Trademark “Shell Naturelle” is used, which is a lithium complex grease designed for extreme pressure with anti-oxidant, anti-wear and anti-rust protection across a wide temperature range. It will be understood that other suitable hydraulic fluids, and preferably environmentally friendly hydraulic fluids, with stable viscosity will be known to the person skilled in the art and may be used instead of “Shell Naturelle”.

Still referring to FIG. 4, it can be seen that the pressurisation module 12B further comprises a pump 240B operatively connected to an electrical motor 241B to drive the pump 240B when required.

The pump 240B has the function of charging the high-pressure accumulator 300B, as will be described in more detail later. In normal operation, the valve (not shown) is held open by pressure from the high-pressure accumulator 300B which holds the actuator 500B in the open position. The actuator 500B may be held in the open position without any electrical power as the hydraulic fluid in the second inner chamber 320B and connection to the first side 531B of the piston 530B is within a closed system such that once the fluid is pressurised it will remain pressurised on the first face 531B, thereby holding the actuator 500B in the open position. The actuator 500B is closed by use of the high-pressure accumulator 300B providing high pressure to the second side 532B of the piston 500B. This is done by switching the high-pressure hydraulic fluid path from providing high pressure fluid from the high-pressure accumulator 300B to the first side 531B to providing high pressure fluid from the high-pressure accumulator 300B to the second side 532B, by use of the directional control valve 400B as is now explained.

The directional control valve 400B in the presently described example is in the form of a four-way solenoid valve. The directional control valve 400B can be put into a first position or a second position. Such a valve is also occasionally referred to as a 4/2 directional control valve. In use, the directional control valve 400B can move between the first and second position.

In the first position (not shown), the directional control valve 400B provides fluid communication between the high-pressure accumulator 300B and the first side 531B of the actuator 500B, and fluid communication between the low-pressure accumulator 300 and the second side 532B of the actuator 500B. In the second position, the directional control valve 400B provides fluid communication between the high-pressure accumulator 300B and the second side 532B of the actuator 500B and fluid communication between the low-pressure accumulator 300B and the first 531B of the actuator 500B.

In this regard, in the first position, the high-pressure accumulator 300B can provide pressurised fluid to the first side 531B, while fluid at the second side 532B does not create a hydraulic lock as it can be released/bled off to the low-pressure accumulator 200B, whereby the hydraulic fluid is maintained in a closed loop.

Similarly, in the second position (shown in FIG. 4), the high-pressure accumulator 300B can provide pressurised fluid to the second side 532B, while fluid at the first side 531B does not create a hydraulic lock as it can be released/bled off to the low-pressure accumulator 200B, whereby the hydraulic fluid is maintained in a closed loop.

To allow the directional control valve 400B to move between the first position and the second position, a solenoid 401B is arranged with a spring 402B. The solenoid 401B and spring 402B together provide operation of the directional control valve 400B. When the solenoid 401B is powered, the solenoid 401B pushes against the spring 402B and maintains the directional control valve 400B in the first position (not shown), that is the directional control valve 400B providing fluid communication between the high-pressure accumulator 300B and the first side 531B of the actuator 500B. When power is lost to the solenoid 401B, the spring 402B automatically pushes the solenoid 401B and thereby moves the directional control valve 400B to the second position (shown in FIG. 4), that is the directional control valve 400B providing fluid communication between the high-pressure accumulator 200B and the second side 532B of the actuator 500B. When the directional control valve 400B is in this second position, high-pressure fluid from the high-pressure accumulator 300B is communicated to the second side 532B of the piston 530B, thereby moving the actuator 500B to the closed position. The directional control valve 400B is controlled by a safety automation system (which may be located remote from the actuator assembly 100B).

The pump 240B functions to pump hydraulic fluid from the low-pressure accumulator 200B to the high-pressure accumulator 300B to recharge the high-pressure accumulator 300B. In this connection, the pump 240B is fluidly connected to the first inner chamber 220B and is fluidly connected to the second inner chamber 320B, to allow recharging of the high-pressure accumulator 300B with fluid from the low-pressure accumulator 200B. In the embodiment described with reference to FIGS. 1 to 3, the pump 240 is a component of the low-pressure accumulator 200 and is located in the first lower chamber 220. It will be appreciated that the pump 240, 240B in either of the two embodiments, may be located anywhere in the assemblies, with fluid connection to the low-pressure 200, 200B and high-pressure 300, 300B accumulator such that the pump 240, 240B can provide the recharging function of the high-pressure accumulator 300, 300B as described. In this connection, the pump in alternative examples may be provided as part of the high-pressure accumulator for example. Alternatively, the pump may be provided as a part of another component of the assembly in another example.

It will be understood that the first piston 230B and second piston 330B allow the nitrogen gas in the first outer chamber 210B and second outer chamber 310B to be compressed to store energy. The nitrogen gas can be allowed to expand again to release the stored energy, thereby moving the pistons 230B, 330B. For the purposes of the above explanation, the pistons 230B, 330B are described as two separate pistons. However, as previously mentioned, the pistons 230B, 330B are part of the double piston accumulator 1200B and are connected internally within the double piston accumulator 1200B as will be explained in more detail later.

The actuator assembly 100B starts operation in a stand-by mode with the actuator 500B closed initially (as shown in FIG. 4) and the directional control valve 400B providing fluid communication between the high-pressure accumulator 300B and the second side 532B of the actuator 500B. The high-pressure accumulator 300B is charged with pressurised hydraulic fluid of four times the valve closure capacity. Depending on the type of operation one, two, three, five or more time the valve closure capacity may be desirable or required. The high-pressure accumulator 300B is charged with pressurised hydraulic fluid of four times the valve closure capacity, such that if required, the high-pressure accumulator 300B could deliver high-pressure hydraulic fluid to the second side 532B of the piston 530B to close the actuator 500B up to four times without being re-charged from the pump 240B connected to the motor 241B.

This also ensures that once the high-pressure accumulator 300B has been used to move the actuator 500B to the open position, there is sufficient pressurised fluid in the high-pressure accumulator 300B to close the actuator 500B again immediately, if required.

In this connection, once the high-pressure accumulator 300B has been sufficiently charged in the stand-by mode, the actuator assembly 100B can be moved to an operational mode. In the operational mode the directional control valve 400B is powered and the solenoid 401B is moved to move the directional control valve 400B from the second position (shown in FIG. 4) to the first position where the directional control valve 400B provides fluid communication between the high-pressure accumulator 300B and the first side 531B of the actuator 500B, and fluid communication between the low-pressure accumulator 300B and the second side 532B of the actuator 500B. The directional control valve 400B will receive a communication signal from the safety automation system to stay in the operational mode.

If power to the directional control valve 400B is lost, or there is a malfunction or loss of communication signal from the safety automation system, the actuator assembly 100B enters a fail-safe closing mode. In the fail-safe closing mode the solenoid 401B is no longer actively powered and is therefore moved by the spring 402B automatically such that the directional control valve 400B returns automatically to the second position shown in FIG. 4. Once the actuator 500B has fully closed, the actuator assembly 100B returns to stand-by mode where the actuator 500B and so the valve, are held in the closed position by the remaining force after the actuator 500B has been closed, without the need for consumption of electrical energy in this closed position. The actuator assembly 100B then starts the above cycle again by recharging the high-pressure accumulator 300B with pressurised hydraulic fluid of four times the valve closure capacity and once the high-pressure accumulator 300B has been sufficiently charged in the stand-by mode, the actuator assembly 100B can be moved to an operational mode as previously described.

Standards may require that the system shall be provided with sufficient back-up power to close the valve three or four or more times without the supply of external power.

Referring again to FIG. 4, further details are now provided which allow safe and reliable operation of the actuator assembly 100B. The inclusion of some components will be self-explanatory to a person skilled in the art, and therefore such components are not explained in detail in the interest of brevity.

In the example shown, the actuator assembly 100B comprises a first flow control valve 403B connected between the directional control valve 400B and the actuator 500B and configured to allow adjustment of the time taken for the valve to open, and a second flow control valve 404B connected between the directional control valve 400B and the actuator 500B and configured to allow adjustment of the time taken for the valve to close. In this connection, between the first flow control valve 403B and the actuator 500B there is provided a first pressure transmitter 410B, and between the second flow control valve 404B and the actuator 500B there is provided a second pressure transmitter 405B.

There is also provided an actuator position transmitter 501B configured to read and transmit the position of the actuator 500B to allow confirmation that the actuator 500B is in the desired position. Similarly, the double piston accumulator 1200B is provided with a piston level transmitter 1231B. By using a double piston accumulator 1200B in the presently described example, it is not required to measure the position of the first piston 230B and second piston 330B individually, since the first and second pistons 230B, 330B are connected and move together. In this connection, the actuator position transmitter 501B can measure either the position of the first piston 230B or the second piston 330B or any point on the connection between the first 230B and second 330B pistons.

There is also provided a pressure limiter 406B in the form of a relief valve. The pressure limiter 406B is operatively connected to the hydraulic fluid flow paths leading from the low-pressure accumulator 200B and the high-pressure accumulator 300B towards the actuator 500B, such that the maximum system pressure will not be exceed a determined threshold value. Exceeding the determined threshold value could cause damage to the actuator 500B, therefore excessively high pressures are released via the pressure limiter 406B.

Similarly, a pressure reducer 407 is operatively connected to the hydraulic flow path leading from the high-pressure accumulator 300B towards the actuator 500B to ensure that the pressure provided to the actuator 500B does not exceed the maximum allowable stem torque. If the maximum allowable stem torque of the valve were to be exceeded, the valve to be operated by the actuator 500B may be damaged.

Still referring to FIG. 4, there is also provided a one-way valve 408B arranged to only allow hydraulic fluid flow from the low-pressure accumulator 200B to the high-pressure accumulator 300B and not from the high-pressure accumulator 300B to the low-pressure accumulator 200B.

Additionally, in the same line as the one-way valve 408, i.e. the connection between the low-pressure accumulator 200B and the high-pressure accumulator 300B, there is provided a filter 409B for filtering and cleaning the hydraulic fluid.

There is provided a first inner chamber temperature transmitter 203B and a first inner chamber pressure transmitter 204B which are configured to read and transmit the pressure in the first inner chamber 220B and the temperature in the first inner chamber 220B, respectively.

Similarly, there is provided a second outer chamber temperature transmitter 301B and a second outer chamber pressure transmitter 302B which are configured to read and transmit the temperature in the second outer chamber 310B and the pressure in the second outer chamber 310B, respectively.

Similarly, there is provided a second inner chamber temperature transmitter 303B and a second inner chamber pressure transmitter 304B which are configured to read and transmit the temperature in the second inner chamber 320B and the pressure in the second inner chamber 320B, respectively.

Still referring to FIG. 4, it can be seen that the pressurisation module 12B is connected to the control module 3B at a first connection 13B. The pressurisation module 12B comprises first one-way valves 13′B which are arranged such that hydraulic fluid may not leak out of the pressurisation module 12B when the pressurisation module 12B is not connected to the control module 3B. Similarly, the control module 3B comprises second one-way valves 13″B which are arranged such that hydraulic fluid may not leak out of the control module 3B when the control module 3B is not connected to the pressurisation module 12B.

The first and second one-way valves 13′B, 13″B are arranged in a stabbing configuration such that when the pressurisation module 12B is stabbed into the control module 3B, the one-way valves are opened and fluid communication in both directions is possible.

The actuator module 4B is releasably connectable to the control module 3B via a second connection 34B. The modular arrangement provided avoids the use of external tubing to connect components and minimises the number of potential leak points in the assembly 100B. Furthermore, handling of the actuator assembly 100B as well as assembly and disassembly is simplified and the time required for each is reduced.

It will be noted that the connection between the low-pressure accumulator 200B and the actuator 500B does not comprise a back pressure limiter as was provided in the example described with reference to FIGS. 1 to 3. In the presently described example a back pressure limiter is not required. It is advantageous to reduce the number of components as this reduces the cost and complexity of the system. Furthermore, the system is easier to service and maintain. In the presently described examples, automatic valve closure is desired. It will be understood that in some systems it may be desirable to automatically open a valve. In this connection, the arrangements may provide fail-safe opening rather than fail-safe closing as described herein.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements.

The mere fact that certain measures are recited in mutually different dependent claims does not indicate that a combination of these measures cannot be used to advantage.

1.-34. (canceled)

35. An actuator system for use with a safety critical valve, the actuator system comprising:
a low-pressure accumulator comprising a first energy store and a first hydraulic fluid chamber;
a high-pressure accumulator comprising a second energy store and a second hydraulic fluid chamber;
a pump;
a directional control valve configured to automatically move from a first position to a second position on loss of a control signal or electrical power;
an actuator comprising a first port for receiving high-pressure hydraulic fluid to open the actuator and a second port for receiving high-pressure hydraulic fluid to close the actuator;
a first hydraulic fluid connection between the pump and the second hydraulic fluid chamber, a second hydraulic fluid connection between the first hydraulic fluid chamber and the directional control valve, a third hydraulic fluid connection between the second hydraulic fluid chamber and the directional control valve; a fourth hydraulic fluid connection between the directional control valve and the first port of the actuator and a fifth hydraulic fluid connection between the directional control valve and the second port of the actuator; wherein
in the first position the directional control valve provides fluid communication between the second hydraulic fluid chamber and the first port and fluid communication between the first hydraulic fluid chamber and the second port and
in the second position the directional control valve provides fluid communication between the second hydraulic fluid chamber and the second port and fluid communication between the first hydraulic fluid chamber and the first port; wherein
the pump is configured to provide pressurized hydraulic fluid from the first hydraulic fluid chamber to the second hydraulic fluid chamber to recharge the high-pressure accumulator such that if the control signal or electrical power is lost to the directional control valve in use, the directional control valve will automatically move to the first position and high-pressure hydraulic fluid will be provided from the second hydraulic fluid chamber to the second port to close the actuator.

36. An actuator system for use with a safety critical valve, the actuator system comprising:
a low-pressure accumulator comprising a first energy store and a first hydraulic fluid chamber;
a high-pressure accumulator comprising a second energy store and a second hydraulic fluid chamber;
a pump;
a directional control valve configured to automatically move from a first position to a second position on loss of a control signal or electrical power;
an actuator comprising a first port for receiving high-pressure hydraulic fluid to close the actuator and a second port for receiving high-pressure hydraulic fluid to open the actuator;
a first hydraulic fluid connection between the pump and the second hydraulic fluid chamber, a second hydraulic fluid connection between the first hydraulic fluid chamber and the directional control valve, a third hydraulic fluid connection between the second hydraulic fluid chamber and the directional control valve; a fourth hydraulic fluid connection between the directional control valve and the first port of the actuator and a fifth hydraulic fluid connection between the directional control valve and the second port of the actuator; wherein
in the first position the directional control valve provides fluid communication between the second hydraulic fluid chamber and the first port and fluid communication between the first hydraulic fluid chamber and the second port and
in the second position the directional control valve provides fluid communication between the second hydraulic fluid chamber and the second port and fluid communication between the first hydraulic fluid chamber and the first port; wherein
the pump is configured to provide pressurized hydraulic fluid from the first hydraulic fluid chamber to the second hydraulic fluid chamber to recharge the high-pressure accumulator such that if the control signal or electrical power is lost to the directional control valve in use, the directional control valve will automatically move to the first position and high-pressure hydraulic fluid will be provided from the second hydraulic fluid chamber to the second port to open the actuator.

37. The actuator system according to claim 35, wherein the system further comprises a sixth hydraulic fluid connection between the pump and the first hydraulic fluid chamber.

38. The actuator system according to claim 37, wherein the low-pressure accumulator and the high-pressure accumulator are provided within a double piston accumulator.

39. A safety critical valve system, comprising:
a safety critical valve configured to be moveable between an open position and a closed position; and
the actuator system according to claim 35;
wherein the actuator is configured with the safety critical valve such that when the actuator is in the open position the safety critical valve is in the open position and when the actuator is in the closed position the safety critical valve is in the closed position.

40. A method of configuring an actuator system such that the actuator system will provide fail-safe closing on loss of a control signal or electrical power, the method comprising the steps of:
providing an actuator system according to claim 35;
operating the pump to pump pressurized hydraulic fluid from the first hydraulic fluid chamber to the second hydraulic fluid chamber to charge the high-pressure accumulator; and
moving the actuator to the open position.

41. A method of configuring an actuator system such that the actuator system will provide fail-safe opening on loss of a control signal or electrical power, the method comprising the steps of:
providing an actuator system according to claim 36;
operating the pump to pump pressurized hydraulic fluid from the first hydraulic fluid chamber to the second hydraulic fluid chamber to charge the high-pressure accumulator; and
moving the actuator to the closed position.

42. A method of operating an actuator system to provide fail-safe closing on loss of a control signal or electrical power, the method comprising the steps of:
providing an actuator system according to claim 35;
operating the pump to pump pressurized hydraulic fluid from the first hydraulic fluid chamber to the second hydraulic fluid chamber to charge the high-pressure accumulator;
moving the actuator to the open position; and
stopping providing electrical power or a control signal to the directional control valve such that the actuator moves to the closed position automatically.

43. A method of operating an actuator system to provide fail-safe opening on loss of a control signal or electrical power, the method comprising the steps of:
providing an actuator system according to claim 36;
operating the pump to pump pressurized hydraulic fluid from the first hydraulic fluid chamber to the second hydraulic fluid chamber to charge the high-pressure accumulator;
moving the actuator to the closed position; and
stopping providing electrical power or a control signal to the directional control valve such that the actuator moves to the open position automatically.

44. A method of configuring a safety critical valve system with fail-safe closing on loss of a control signal or electrical power, the method comprising the steps of:
providing a safety critical valve system, comprising:
a safety critical valve configured to be moveable between an open position and a closed position; and
the actuator system according to claim 35;
wherein the actuator is configured with the safety critical valve such that when the actuator is in the open position the safety critical valve is in the open position and when the actuator is in the closed position the safety critical valve is in the closed position;
operating the pump to pump pressurized hydraulic fluid from the first hydraulic fluid chamber to the second hydraulic fluid chamber to charge the high-pressure accumulator; and
opening the safety critical valve by moving the actuator to the open position.

45. A method of configuring a safety critical valve system with fail-safe opening on loss of a control signal or electrical power, the method comprising the steps of:
providing a safety critical valve system, comprising:
a safety critical valve configured to be moveable between an open position and a closed position; and
the actuator system according to claim 36;
wherein the actuator is configured with the safety critical valve such that when the actuator is in the open position the safety critical valve is in the open position and when the actuator is in the closed position the safety critical valve is in the closed position;
operating the pump to pump pressurized hydraulic fluid from the first hydraulic fluid chamber to the second hydraulic fluid chamber to charge the high-pressure accumulator; and
closing the safety critical valve by moving the actuator to the closed position.

46. A method of operating a safety critical valve system to provide fail-safe closing on loss of a control signal or electrical power, the method comprising the steps of:
providing a safety critical valve system, comprising:
a safety critical valve configured to be moveable between an open position and a closed position; and
the actuator system according to claim 35;
wherein the actuator is configured with the safety critical valve such that when the actuator is in the open position the safety critical valve is in the open position and when the actuator is in the closed position the safety critical valve is in the closed position;
operating the pump to pump pressurized hydraulic fluid from the first hydraulic fluid chamber to the second hydraulic fluid chamber to charge the high-pressure accumulator;
moving the actuator to the open position; and
automatically closing the safety critical valve by stopping providing electrical power or a control signal to the directional control valve such that the actuator moves to the closed position automatically.

47. A method of operating a safety critical valve system to provide fail-safe opening on loss of a control signal or electrical power, the method comprising the steps of:
providing a safety critical valve system, comprising:
a safety critical valve configured to be moveable between an open position and a closed position; and
the actuator system according to claim 36;
wherein the actuator is configured with the safety critical valve such that when the actuator is in the open position the safety critical valve is in the open position and when the actuator is in the closed position the safety critical valve is in the closed position;
operating the pump to pump pressurized hydraulic fluid from the first hydraulic fluid chamber to the second hydraulic fluid chamber to charge the high-pressure accumulator;
moving the actuator to the closed position; and
automatically opening the safety critical valve by stopping providing electrical power or a control signal to the directional control valve such that the actuator moves to the open position automatically.

48. An actuator kit for assembling an actuator system for use with a safety critical valve, the actuator kit comprising:
a low-pressure module comprising a low-pressure accumulator;
a high-pressure module comprising a high-pressure accumulator;
a control module; and
an actuator module; wherein
the low-pressure accumulator comprises a first energy store and a first hydraulic fluid chamber comprising a pump, and the high-pressure accumulator comprises a second energy store and a second hydraulic fluid chamber;
the control module comprises a directional control valve configured to automatically move from a first position to a second position on loss of a control signal or electrical power;
the actuator module comprises an actuator comprising a first port for receiving high-pressure hydraulic fluid to open the actuator and a second port for receiving high-pressure hydraulic fluid to close the actuator;
the low-pressure module and high-pressure module are configured to be fluidly couplable with the control module such that when coupled;
a first hydraulic fluid connection is formed between the pump and the second hydraulic fluid chamber such that the pump can provide pressurized hydraulic fluid from the first hydraulic fluid chamber to the second hydraulic fluid chamber to recharge the high-pressure accumulator;
a second hydraulic fluid connection is formed between the first hydraulic fluid chamber and the directional control valve;
a third hydraulic fluid connection is formed between the second hydraulic fluid chamber and the directional control valve;
the control module is configured to be fluidly couplable with the actuator module such that when coupled;
a fourth hydraulic fluid connection is formed between the directional control valve and the first port of the actuator; and
a fifth hydraulic fluid connection is formed between the directional control valve and the second port of the actuator;
such that when the actuator kit is assembled into an actuator system and is in use, if the control signal or electrical power is lost to the directional control valve, the directional control valve will automatically move to the first position and high-pressure hydraulic fluid will be provided from the second hydraulic fluid chamber to the second port to close the actuator.

49. An actuator kit for assembling an actuator system for use with a safety critical valve, the actuator kit comprising:
A low-pressure module comprising a low-pressure accumulator;
a high-pressure module comprising a high-pressure accumulator;
a control module; and
an actuator module; wherein
the low-pressure accumulator comprises a first energy store and a first hydraulic fluid chamber comprising a pump, and the high-pressure accumulator comprises a second energy store and a second hydraulic fluid chamber;
the control module comprises a directional control valve configured to automatically move from a first position to a second position on loss of a control signal or electrical power;
the actuator module comprises an actuator comprising a first port for receiving high-pressure hydraulic fluid to close the actuator and a second port for receiving high-pressure hydraulic fluid to open the actuator;
the low-pressure module and high-pressure module are configured to be fluidly couplable with the control module such that when coupled;
a first hydraulic fluid connection is formed between the pump and the second hydraulic fluid chamber such that the pump can provide pressurized hydraulic fluid from the first hydraulic fluid chamber to the second hydraulic fluid chamber to recharge the high-pressure accumulator;
a second hydraulic fluid connection is formed between the first hydraulic fluid chamber and the directional control valve;
a third hydraulic fluid connection is formed between the second hydraulic fluid chamber and the directional control valve;
the control module is configured to be fluidly couplable with the actuator module such that when coupled;
a fourth hydraulic fluid connection is formed between the directional control valve and the first port of the actuator; and
a fifth hydraulic fluid connection is formed between the directional control valve and the second port of the actuator;
such that when the actuator kit is assembled into an actuator system and is in use, if the control signal or electrical power is lost to the directional control valve, the directional control valve will automatically move to the first position and high-pressure hydraulic fluid will be provided from the second hydraulic fluid chamber to the second port to open the actuator.

50. An actuator kit for assembling an actuator system for use with a safety critical valve, the actuator kit comprising:
a pressurization module comprising a double piston accumulator;
a control module; and
an actuator module; wherein
the double piston accumulator comprises a low-pressure accumulator and a high-pressure accumulator;
the low-pressure accumulator comprises a first energy store and a first hydraulic fluid chamber comprising a pump, and the high-pressure accumulator comprises a second energy store and a second hydraulic fluid chamber;
the control module comprises a directional control valve configured to automatically move from a first position to a second position on loss of a control signal or electrical power;
the actuator module comprises an actuator comprising a first port for receiving high-pressure hydraulic fluid to open the actuator and a second port for receiving high-pressure hydraulic fluid to close the actuator;
the pressurization module is configured to be fluidly couplable with the control module such that when coupled;
a first hydraulic fluid connection is formed between the pump and the second hydraulic fluid chamber such that the pump can provide pressurized hydraulic fluid from the first hydraulic fluid chamber to the second hydraulic fluid chamber to recharge the high-pressure accumulator;
a second hydraulic fluid connection is formed between the first hydraulic fluid chamber and the directional control valve;
a third hydraulic fluid connection is formed between the second hydraulic fluid chamber and the directional control valve;
the control module is configured to be fluidly couplable with the actuator module such that when coupled;
a fourth hydraulic fluid connection is formed between the directional control valve and the first port of the actuator; and
a fifth hydraulic fluid connection is formed between the directional control valve and the second port of the actuator;
such that when the actuator kit is assembled into an actuator system and is in use, if the control signal or electrical power is lost to the directional control valve, the directional control valve will automatically move to the first position and high-pressure hydraulic fluid will be provided from the second hydraulic fluid chamber to the second port to close the actuator.

51. An actuator kit for assembling an actuator system for use with a safety critical valve, the actuator kit comprising:
a pressurization module comprising a double piston accumulator;
a control module; and
an actuator module; wherein
the double piston accumulator comprises a low-pressure accumulator and a high-pressure accumulator;
the low-pressure accumulator comprises a first energy store and a first hydraulic fluid chamber comprising a pump, and the high-pressure accumulator comprises a second energy store and a second hydraulic fluid chamber;
the control module comprises a directional control valve configured to automatically move from a first position to a second position on loss of a control signal or electrical power;
the actuator module comprises an actuator comprising a first port for receiving high-pressure hydraulic fluid to close the actuator and a second port for receiving high-pressure hydraulic fluid to open the actuator;
the pressurization module is configured to be fluidly couplable with the control module such that when coupled;
a first hydraulic fluid connection is formed between the pump and the second hydraulic fluid chamber such that the pump can provide pressurized hydraulic fluid from the first hydraulic fluid chamber to the second hydraulic fluid chamber to recharge the high-pressure accumulator;
a second hydraulic fluid connection is formed between the first hydraulic fluid chamber and the directional control valve;
a third hydraulic fluid connection is formed between the second hydraulic fluid chamber and the directional control valve;
the control module is configured to be fluidly couplable with the actuator module such that when coupled;
a fourth hydraulic fluid connection is formed between the directional control valve and the first port of the actuator; and
a fifth hydraulic fluid connection is formed between the directional control valve and the second port of the actuator;
such that when the actuator kit is assembled into an actuator system and is in use, if the control signal or electrical power is lost to the directional control valve, the directional control valve will automatically move to the first position and high-pressure hydraulic fluid will be provided from the second hydraulic fluid chamber to the second port to open the actuator.

52. An actuator kit for assembling an actuator system for use with a safety critical valve, the actuator kit comprising:
a pressurization module comprising:
a pump; and
a double piston accumulator comprising a low-pressure accumulator and a high-pressure accumulator;
a control module; and
an actuator module; wherein
the low-pressure accumulator comprises a first energy store and a first hydraulic fluid chamber, and the high-pressure accumulator comprises a second energy store and a second hydraulic fluid chamber;
the pressurization module further comprises a first hydraulic fluid connection between the pump and the second hydraulic fluid chamber such that the pump can provide pressurized hydraulic fluid from the first hydraulic fluid chamber to the second hydraulic fluid chamber to recharge the high-pressure accumulator;
the control module comprises a directional control valve configured to automatically move from a first position to a second position on loss of a control signal or electrical power;
the actuator module comprises an actuator comprising a first port for receiving high-pressure hydraulic fluid to open the actuator and a second port for receiving high-pressure hydraulic fluid to close the actuator;
the pressurization module is configured to be fluidly couplable with the control module such that when coupled;
a second hydraulic fluid connection is formed between the first hydraulic fluid chamber and the directional control valve;
a third hydraulic fluid connection is formed between the second hydraulic fluid chamber and the directional control valve;
the control module is configured to be fluidly couplable with the actuator module such that when coupled;
a fourth hydraulic fluid connection is formed between the directional control valve and the first port of the actuator; and
a fifth hydraulic fluid connection is formed between the directional control valve and the second port of the actuator;
such that when the actuator kit is assembled into an actuator system and is in use, if the control signal or electrical power is lost to the directional control valve, the directional control valve will automatically move to the first position and high-pressure hydraulic fluid will be provided from the second hydraulic fluid chamber to the second port to close the actuator.

53. An actuator kit for assembling an actuator system for use with a safety critical valve, the actuator kit comprising:
a pressurization module comprising:
a pump; and
a double piston accumulator comprising a low-pressure accumulator and a high-pressure accumulator;
a control module; and
an actuator module; wherein
the low-pressure accumulator comprises a first energy store and a first hydraulic fluid chamber, and the high-pressure accumulator comprises a second energy store and a second hydraulic fluid chamber;
the pressurization module further comprises a first hydraulic fluid connection between the pump and the second hydraulic fluid chamber such that the pump can provide pressurized hydraulic fluid from the first hydraulic fluid chamber to the second hydraulic fluid chamber to recharge the high-pressure accumulator;
the control module comprises a directional control valve configured to automatically move from a first position to a second position on loss of a control signal or electrical power;
the actuator module comprises an actuator comprising a first port for receiving high-pressure hydraulic fluid to close the actuator and a second port for receiving high-pressure hydraulic fluid to open the actuator;
the pressurization module is configured to be fluidly couplable with the control module such that when coupled;
a second hydraulic fluid connection is formed between the first hydraulic fluid chamber and the directional control valve;
a third hydraulic fluid connection is formed between the second hydraulic fluid chamber and the directional control valve;
the control module is configured to be fluidly couplable with the actuator module such that when coupled;
a fourth hydraulic fluid connection is formed between the directional control valve and the first port of the actuator; and
a fifth hydraulic fluid connection is formed between the directional control valve and the second port of the actuator;
such that when the actuator kit is assembled into an actuator system and is in use, if the control signal or electrical power is lost to the directional control valve, the directional control valve will automatically move to the first position and high-pressure hydraulic fluid will be provided from the second hydraulic fluid chamber to the second port to open the actuator.
